(19) United States
(12) Patent Application Publication
(10) Pub. No.: US 2020/0087215 A1
(43) Pub. Date: Mar. 19, 2020

(54) LIGHTER WEIGHT COMPOSITION MATERIAL WITH LOW THERMAL CONDUCTIVITY

(71) Applicant: Steven Patrick Miles, Johnson City, TN (US)

(72) Inventor: Steven Patrick Miles, Johnson City, TN (US)

(21) Appl. No.: 16/135,614

(22) Filed: Sep. 19, 2018

(51) Int. Cl. C04B 38/10; C04B 40/00; C04B 28/04

(52) U.S. Cl. CPC C04B 38/106; C04B 2103/42; C04B 28/04; C04B 40/0046

(57) ABSTRACT

A method of making a composition material comparable to strength with regular concrete but with a lower weight and thermal conductivity is provided. The process includes forming a first composition from a foam admixture of a first cementitious slurry and foam. This first composition is set and then pulverized to a fine dust. The fine dust is then added to a second cementitious slurry, producing a lightweight and insulative composition material for construction applications.

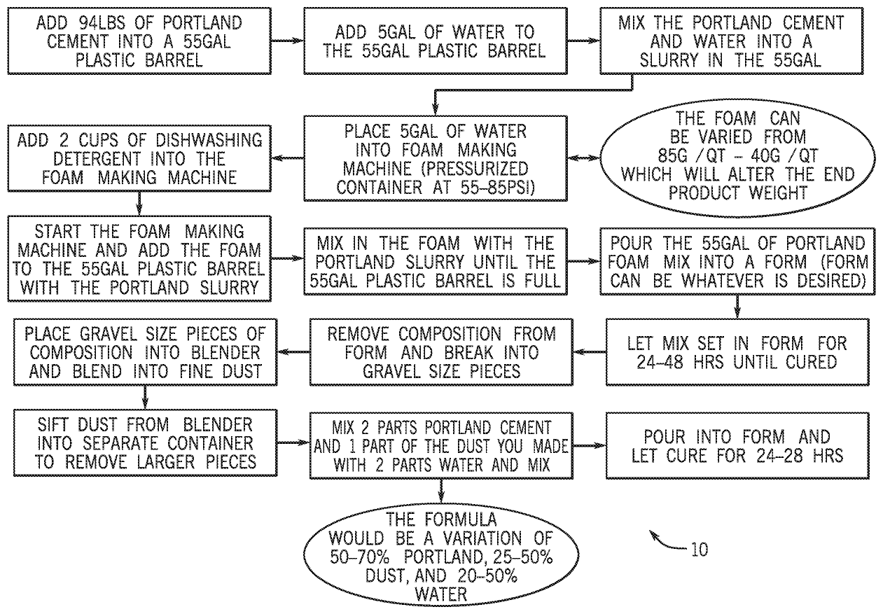

### BACKGROUND OF THE INVENTION

The present invention relates to composition materials and, more particularly, to a lightweight composition material with a lower thermal conductivity than regular concrete.

Composite material is a made from two or more constituent materials with significantly different physical or chemical properties that, when combined, produce a material with characteristics different from the individual components. The individual components remain separate and distinct within the finished structure. For structural applications, concrete is the most popular composition material. Concrete is composed of fine and coarse aggregate bonded together with a fluid cement paste that hardens over time. Unfortunately, regular concrete is heavy and will not provide sufficient detailing properties in the end product for some structural applications. Furthermore, regular concrete has thermal conductivity properties such that heat will too easily transfer through structural concrete, requiring the use of insulation in thermal-sensitive applications. And so, there are many applications where the weight of regular concrete, the detailing properties, and thermal conductivity are disadvantageous.

As can be seen, there is a need for a lightweight composition material with low thermal conductivity. The composition material of the present invention has a lighter weight than normal concrete, provides greater detailing properties in the end product, and does not take in heat (i.e. you can put your hand on one side of a ¾″ slab of this product and put a torch to the other side and the heat will not penetrate to the side your bare hand is on). The inventive composition material is also a great insulator for sound as well as temperature changes.

By using a different group of aggregates, the present invention provides a composition material that is roughly 50% the weight of regular concrete, and will provide incredible detail to the end product for structural components normally made out of concrete. Again, the composition material of the present invention provides better insulative value as it does not transfer heat as well as being fireproof.

### SUMMARY OF THE INVENTION

In one aspect of the present invention, a method of making a composition material includes the steps of: providing a first cementitious slurry; adding a foam to the first cementitious slurry, forming a foam admixture; setting the foam admixture, producing a first composition; pulverizing the first composition; and adding the pulverized first composition to a second cementitious slurry.

In another aspect of the present invention, the method of making a composition material includes the steps of: providing a first cementitious slurry; providing a foam comprising a ratio of water to dishwashing soap ranges between 85 gallons water to one-quart dishwashing detergent and 40 gallons water to one-quart dishwashing detergent; adding the foam to the first cementitious slurry, forming a foam admixture; setting the foam admixture in a preselected form, producing a first composition; pulverizing the first composition to a gravel-sized (0.12-1.5 inch in diameter) particulate; blending the gravel-sized particulate to a dust (40-1000 micrometers in diameter); adding the dust to a second cementitious slurry, wherein the dust and the second cementitious slurry forms a composition material slurry; and pouring the composition material slurry in said preselected form, wherein no aggregates other than Portland cement or the dust is added to the first and second cementitious slurries.

These and other features, aspects and advantages of the present invention will become better understood with reference to the following drawings, description and claims.

### BRIEF DESCRIPTION OF THE DRAWINGS

The FIGURE is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of making a composition material comparable to strength with regular concrete but with a lower weight and thermal conductivity. The process includes forming a first composition from a foam admixture of a first Portland slurry and foam. This first composition is set and then pulverized to a fine dust and added to a second Portland slurry, ready for use for construction applications.

Referring to the sole FIGURE, the present invention may include a method 10 for producing an inventive composition material that provides a lower specific weight and thermal conductivity as compared to regular concrete, as well as comparatively superior detailing properties.

It should be noted that that the measurement provided below are for illustrative purposes, and so that the measurements may change as long ratios are within a given range, the present invention will function as disclosed herein. The method includes the following steps: step 1, adding 94 pounds of Portland cement to a 55-gallon plastic container; step 2, adding 5 gallons of water to the 55-gallon container; step 3, mixing Portland cement and water into a slurry in the 55-gallon container; step 4, placing 5 gallons of water into a foam making machine (pressurized container at 55-85 psi); step 5, adding two cups of dishwashing detergent into the foam making machine; step 6, starting the foam making machine and adding the resulting foam to the 55-gallon container with the Portland slurry; step 7, mixing in the foam with the Portland slurry until the 55-gallon container is full; step 8, pouring the 55-gallon of Portland foam admixture into a form; step 9, letting the first composition (resulting in a foam admixture) set in form for 24-48 hours until cured; step 10, removing the first composition from the form and pulverizing into a gravel-size (0.12-1.5 inch in diameter) particulate; step 11, blending the gravel-size particulate of the first composition into a fine dust (40-1000 micrometers in diameter); step 12, sifting the fine dust (flour sifter) from blender into separate container to remove larger pieces; step 13, mixing two parts Portland cement and one part of the fine dust with two parts water and mix (note, this ratio or formula may vary depending on the desired end product' weight, detail and/or texture—e.g., in one embodiment it may be 50-75% Portland, 25-50% dust, and 20-50% water); and step 14, pouring into form and let cure for 24-48 hours.

In steps 4 through 6, a foam making machine capable of handling Portland cement is required. An industrial blender may be used to blend the gravel-size particulate in step 11. In certain embodiments, a flour sifter may be used to sift the fine dust.

The first component that is made and then pulverized into dust is necessary for any application as well as the addition of the Portland slurry with this dust. If a stronger composition material is desired and weight is not an issue, a user could add regular sand or gravel. The mix ratios can be determined and varied for different end products, depending on what end product properties are desired. For example, one may add additional Portland for better detail on the end product; one can add sand or gravel for better strength (which increases the weight); one can add less Portland and more dust for even lighter weight (but lose some of the detailing properties). Adding polyester fibers significantly increases the overall strength as well.

The resulting composition material is substantially lighter than traditional sand that is used in concrete. With the use of the foam mixed in with the Portland, small air pockets are created in the first composition material that reduce the weight which carries with the first composition material through the pulverizing process. By adding the pulverized first composition as opposed to traditional sand, the end product is significantly lighter than traditional concrete. Pulverizing the first composition to a fine sand also provides for the ability to get significantly greater detail in the end product. The resulting “air pockets” are also the reason the end product does not conduct heat.

The present invention provides the ability to make more detailed products than regular concrete. The present invention can be used in areas where the weight of regular concrete makes using concrete a non-viable option; for example, providing the opportunity to make items that would normally be made out of concrete but where the weight prevents the ready ability to handle/move the product without heavy equipment. The thermal conductivity of the resulting composition material is adapted to be significantly more useful in areas where extreme temperature changes are an issue.

Additionally, the present invention can be used in a variety of different fields of technology, i.e., used as a substitute for insulation, or used as insulative panels for fire proofing. Also, it can create insulation panels; dog houses; log homes; roofing components; patio pavers; pizza ovens; driveways; bricks; blocks; sidewalks; statues; figurines; hunting blinds; etc.

It should be understood, of course, that the foregoing relates to exemplary embodiments of the invention and that modifications may be made without departing from the spirit and scope of the invention as set forth in the following claims.

What is claimed is:

1. A method of making a composition material, comprising the steps of:
providing a first cementitious slurry;
adding a foam to the first cementitious slurry, forming a foam admixture;
setting the foam admixture, producing a first composition;
pulverizing the first composition; and
adding the pulverized first composition to a second cementitious slurry.

2. The method of claim 1, wherein the foam comprising water and dishwashing detergent.

3. The method of claim 2, wherein a ratio of water to dishwashing soap ranges between 85 gallons water to one-quart dishwashing detergent and 40 gallons water to one-quart dishwashing detergent.

4. The method of claim 1, wherein the first composition is first pulverized to a gravel-sized particulate and then further comprising the step of blending the gravel-sized particulate to a dust,
whereby the dust is used in lieu of sand in a standard concrete aggregate mix.

5. The method of claim 1, wherein the pulverized first composition and the second cementitious slurry forms a composition material slurry.

6. The method of claim 5, wherein the first composition is set in a preselected form; and further comprising the step of pouring the composition material slurry in said preselected form,
whereby a predetermined amount of pulverized first composition is added to the second cementitious slurry.

7. The method of claim 1, wherein no aggregates other than Portland cement or the dust is added to the first and second cementitious slurries.

8. A method of making a composition material, comprising the steps of:
providing a first cementitious slurry;
providing a foam comprising a ratio of water to dishwashing soap ranges between 85 gallons water to one-quart dishwashing detergent and 40 gallons water to one-quart dishwashing detergent;
adding the foam to the first cementitious slurry, forming a foam admixture;
setting the foam admixture in a preselected form, producing a first composition;
pulverizing the first composition to a gravel-sized particulate;
blending the gravel-sized particulate to a dust;
adding the dust to a second cementitious slurry, wherein the dust and the second cementitious slurry forms a composition material slurry; and
pouring the composition material slurry in said preselected form.

9. The method of claim 8, wherein no aggregates other than Portland cement or the dust is added to the first and second cementitious slurries.

10. A composition of matter, comprising the composition material slurry of claim 9.
